(19) United States
(12) Patent Application Publication
(10) Pub. No.: US 2020/0102789 A1
(43) Pub. Date: Apr. 2, 2020

(54) LADDER LIFTING ASSEMBLY

(71) Applicant: Lewis Young, Greenville, SC (US)

(72) Inventor: Lewis Young, Greenville, SC (US)

(21) Appl. No.: 16/578,829

(22) Filed: Sep. 23, 2019

Related U.S. Application Data
(60) Provisional application No. 62/738,884, filed on Sep. 28, 2018.

(51) Int. Cl. E06C 7/12; E06C 1/12; E06C 7/46

(52) U.S. Cl. CPC E06C 7/12; E06C 7/46; E06C 1/12

(57) ABSTRACT

A ladder lifting assembly includes a shuttle for carrying workpieces to elevated positions such as rooftops. The assembly may include a winch, a pulley assembly, and an anchoring system for attachment to an extension ladder to which the ladder lifting assembly is movably connected.

### CROSS-REFERENCE TO RELATED APPLICATIONS

This utility patent application claims benefit of U.S. Provisional Patent Application Ser. No. 62/738,884, filed in the United States Patent and Trademark Office on Sep. 28, 2018, which is incorporated herein by reference in its entirety.

### BACKGROUND OF THE DISCLOSURE

Roofers, solar panel installers and the like use extension ladders to climb onto roofs of homes and buildings to install solar panels, tar paper, shingles, and other components. The roofs may be twenty to fifty feet from the ground, and many angle upward from their lowest points to allow for water runoff and to prevent debris from collecting.

Workers sometimes carry components in one hand while climbing a ladder with the other hand, or they rig a strap to lift the components to the roof, particularly in situations where a mechanical lift is unavailable or impractical, such as on soft turf. Transporting dozens of shingles, panels or the like from the ground to a roof top for installation can be dangerous as the unwieldy, heavy components are maneuvered and handed from a worker on the ladder to another worker on the roof. If straps or other makeshift lifting arrangements are used to haul the components to the roof top, the building or home may be bumped by unstable components, which can damage both the components and the building. Furthermore, such makeshift lifting is time consuming, which increases project costs.

What is needed in the industry is a system for delivering components to roof tops or other out of reach places in less time with less risk to workers, structures, and components.

### BRIEF SUMMARY OF THE DISCLOSURE

The present disclosure is directed in general to an assembly for use with an extension ladder for safely and quickly delivering solar panels, tar paper, shingles, and other heavy or unwieldy components to roof tops or other elevated places.

In one embodiment according to the disclosure, a ladder lifting assembly may include a shuttle having a cradle configured for carrying a workpiece to an elevated position; attachment means, such as ladder blocks, a magnet pad and a trolley, for movably connecting the shuttle to an extension ladder, the extension ladder being configured to extend to the elevated position; a pulley assembly attached to the extension ladder, the pulley assembly including a cable attached to the shuttle; and a hoist connected to the extension ladder, the cable connecting the hoist to the shuttle through the pulley assembly, wherein when the hoist is activated in a first state, the shuttle is raised in a direction of the elevated position, and wherein when the hoist is activated in a second state, the shuttle is lowered in a direction away from the elevated position.

The hoist may be a motorized winch attached at a bottom end of the extension ladder, and the elevated position may be a roof top.

A ground anchor assembly may be connected to the extension ladder and include one or more anchors, such as ground screws, for anchoring the extension ladder to the ground.

In another embodiment, a method of loading and elevating solar panels for installation may include providing a shuttle having a cradle to carry a solar panel; providing an extension ladder; extending the extension ladder to a desired elevation; providing a motorized hoist; attaching the hoist to the extension ladder; movably attaching the shuttle to the extension ladder; attaching a pulley system to the extension ladder; connecting a cable to the shuttle and to the hoist, the cable extending through the pulley system; loading the solar panel on the shuttle; and activating the hoist and raising the solar panel on the shuttle along the extension ladder in a direction of the elevated position; and unloading the solar panel from the shuttle.

The exemplary method may also include providing a ground anchor assembly connected to the extension ladder and anchoring the extension ladder to ground.

Other embodiments include the foregoing and other elements and steps described herein, and their equivalents, in various combinations.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is an elevational view of an embodiment of a ladder lift assembly according to an aspect of the disclosure with some aspects shown partially cutaway for clarity;

FIG. 2 is a partial, perspective, top-end view of components of the embodiment as in FIG. 1 with some aspects shown partially cutaway and in phantom for clarity;

FIG. 3 is a perspective, partial view of another embodiment of a ladder lift assembly according to another aspect of the disclosure with some aspects shown partially cutaway for clarity;

FIG. 4 is another partial perspective view of the components as in FIG. 3 shown in an intended use environment;

FIG. 5 is a partial perspective view of the embodiment as in FIG. 4 shown in one stage of operation;

FIG. 6 is a partial perspective view of the embodiment as in FIG. 4 shown in another stage of operation; and

FIG. 7 is a partial perspective view of the embodiment as in FIG. 4 shown in a further stage of operation.

### DETAILED DESCRIPTION OF THE DISCLOSURE

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

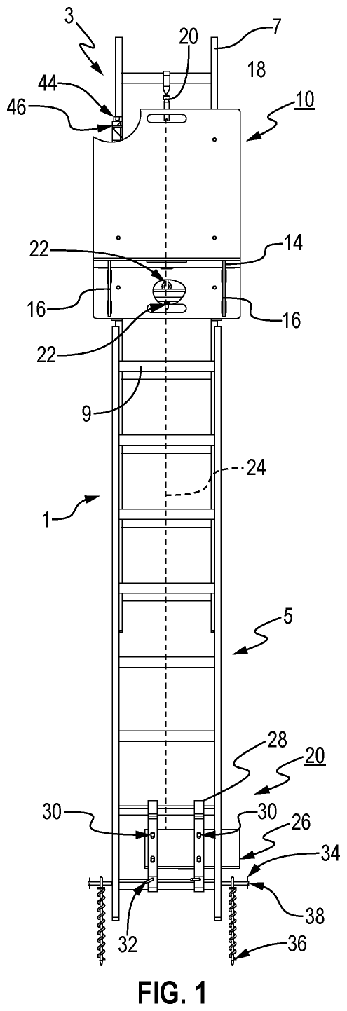

Turning now to FIG. 1, a ladder lift assembly, also known as a Panelvator™ brand hoist, car, cradle, carrier or shuttle, is designated in general by the number 10. The assembly 10 is operably connected to an extension ladder 1, which in this example includes a first extension section 3 and a second extension section 5, each section being about ten to twenty feet (10-20′) in length and each having left and right vertical struts 7 with horizontal rungs 9 attached therebetween. The ladder 1 may include more than two sections 3, 5, or the sections 3, 5 may be shorter or longer than ten to twenty feet as needed. The exemplary ladder 1 may be made from metal such as steel or reinforced aluminum or other durable but preferably light-weight material such as plastic, high-density polyethylene (HDPE) and the like.

FIG. 1 further shows that the ladder lift assembly 10 may include a substantially vertically oriented shuttle back or base 12 and a substantially horizontally oriented shuttle seat, stand, or holder 14. In this example, a width of the shuttle base 12 is the approximately the same width of the shuttle seat 14 and slightly wider than a width of the extension ladder 1. More particularly, the base 12 and the seat 14 may be made of HDPE material and are approximately twenty-four inches (24″) wide. In one aspect, the base 12 is approximately thirty-four inches (34″) in height, and the seat 14 is approximately eleven inches (11″) in depth. The disclosure is not limited to these dimensions, which can be modified to accommodate different materials or components to be lifted on the assembly 10, as will be described by example operation below.

Also shown in FIG. 1, one or more shuttle gussets 16 may be provided between the base 12 and the seat 14 to maintain the seat 14 substantially perpendicular to the base 12, particularly when the ladder lift assembly 10 is transporting a load. Also shown, one or both of the base 12 and the seat 14 may have handles, grips, or apertures 18 to assist in carrying and installing or removing the ladder lift assembly 10 from the ladder 1.

A pulley assembly 20 may be provided with the ladder lift assembly 10 as shown in FIG. 1. In one aspect, the pulley assembly 20 may be attached at or near the top most horizontal rung 9 of the ladder 1. As shown in a partial cutaway of FIG. 1 for clarity, a cap hook and eye bolt 22 may be connected to a rear side of the base 12 to lift the base 12 and the seat 14 with a load from the bottom of the ladder 1. The pulley assembly 20 has a rope, cable, or metal cord 24 (shown in phantom for clarity) connected to a motor assembly, winch or hoist 26. The hoist 26 may include brackets 28 to attach the hoist 26 to rungs 9 of the ladder 1. Here, the hoist 26 can be connected to the brackets 28 using bolts 30, for instance, and the brackets can be secured to at least one of the rungs 9 using a hitch pin 32. When the motor assembly 26 is activated, for instance, by remote control, the cable 24 either unwinds or winds via the pulley assembly 20 to raise the base 12 and the seat 14 with their load, or to lower them as the case may be.

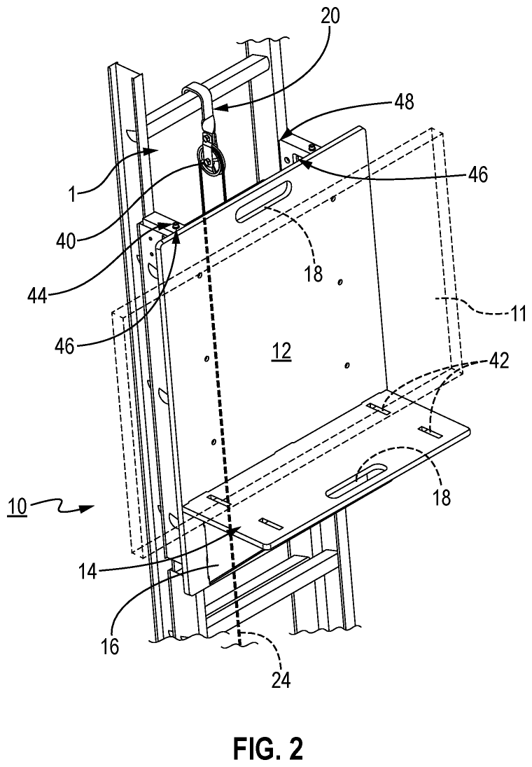

FIG. 1 further shows that, prior to placing a load on the base 12 and seat 14, the ladder 1 may be anchored and stabilized using an anchor rod 34 and ground anchors or screws 36. As shown, the anchor rod 32 may extend through either side of the struts 7 and connected thereto using cotter keys or pins 38. The anchors 36 are screwed or inserted in the ground to hold the ladder 1 and the assembly 10 steady when under load with workpieces as shown in FIG. 2 and described below.

FIG. 2 most clearly shows the base 12, the seat 14, and the gusset 16 of the ladder lift assembly 10 attached to the ladder 1. In addition to the handles 18 in the base 12 and seat 14, a number of tie-down apertures 40 may be provided to strap a workpiece, such as a solar panel 11, to the seat 14. Here also, the pulley assembly 20 may include a wheel or pulley 40 with the cable 24 running therethrough, which is connected to the base 12 and to the winch 26 (see FIG. 1). The solar panel 11 is shown in phantom for clarity and seated against the base 12 and on the seat 14 (straps or tie-downs are not shown for further clarity). The exemplary solar panel 11 may be approximately five feet (5′) by three feet (3′) and weigh approximately forty pounds (40 lbs.). Thus, the assembly 10 can be used safely to deliver dozens of panels 11 to a roof top while taking only seconds per panel 11.

Also shown in FIG. 2 are blocks 44, 48 which connect the assembly 10 to the ladder 1 as introduced in FIG. 1. As shown, a magnet pad 46 with a steel angle can be provided to attach and adjust the assembly 10 relative to the ladder 1.

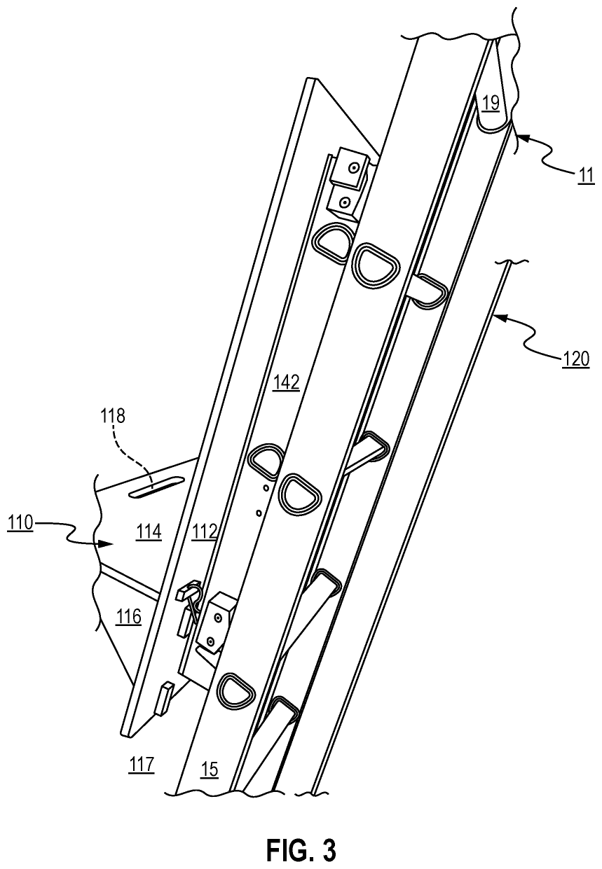

Turning now to FIG. 3, a ladder lift assembly or shuttle 110 is attached to an extension ladder 11. The shuttle 110 includes one or more shuttle gussets 116 arranged between a base 112 and a seat 114 to maintain the seat 114 substantially perpendicular to the base 112, particularly when the shuttle 110 is transporting a load. Also shown, one or both of the base 112 and the seat 114 may have handles, grips, or apertures 118 to assist in carrying and installing or removing the shuttle 110 from the ladder 11. The base 112 is connected to a shuttle slide or trolley 142, which is connected in turn to the extension ladder 11 as explained in further detail below. Also, the shuttle 110 also includes pulley assembly 120, which may be attached at or near a top most horizontal rung 19 of the ladder 11.

In usage, the extension ladder 11 is placed near a structure such as a home or building where it will be used, typically to reach a roof of the structure. As shown in FIG. 3, a ladder section 15, which has “gripping” feet that rest on the ground 117 is attached to a face or front of an upper section of the ladder 11. This allows a person setting the ladder's height to increase the total length of the extension by pulling on a rope or cable of the pulley assembly 120. If the shuttle 110 were to be attached to the section 15 resting on the ground 117, the second section would act as a blockade and prevent the shuttle 110 from going any further. By initially determining the desired height and setting the locking hooks on the ladder at this desired height, and then flipping the ladder 180 degrees, the shuttle 110, now attached to the opposite side of the bottom section, will travel the full distance from the bottom of the section 15 (which is resting on the ground 117) until the shuttle 110 is transferred to the trolley 142 as it reaches the top of the section and continues being pulled to the top of the ladder 11.

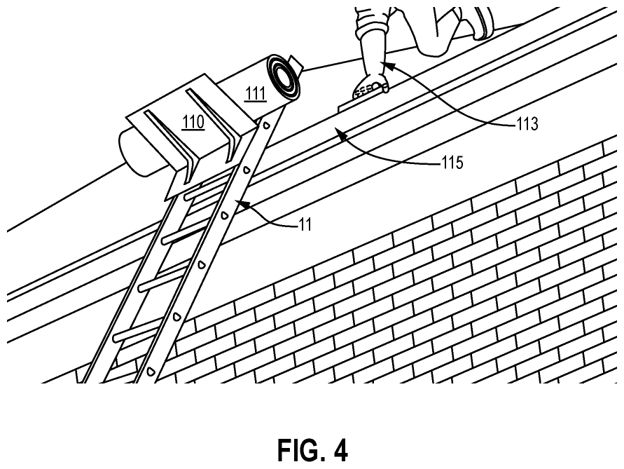

FIG. 4 shows the shuttle 110 being used to lift a heavy, unwieldy roll of tar paper 111 into position for a worker 113 to retrieve at a rooftop 115. More specifically, the shuttle 110 enables a worker on the ground to load the assembly 110 and winch the tar paper 111 up to the second man 113 with less danger to both. As shown, the assembly 110 ensures that no one has to climb the ladder 11 while manually carrying the tar paper 111.

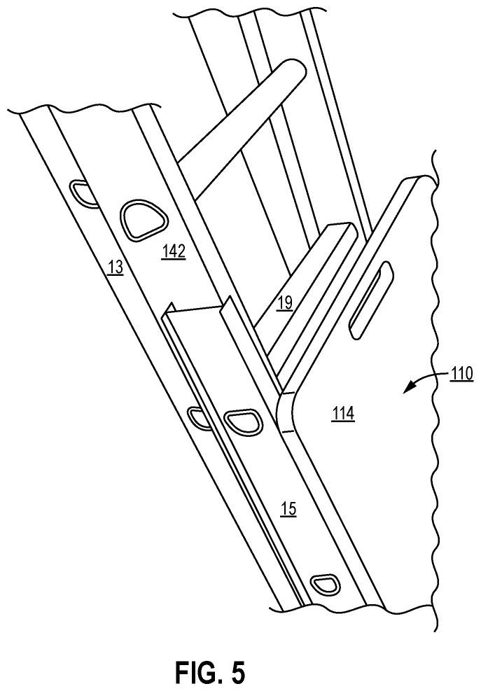

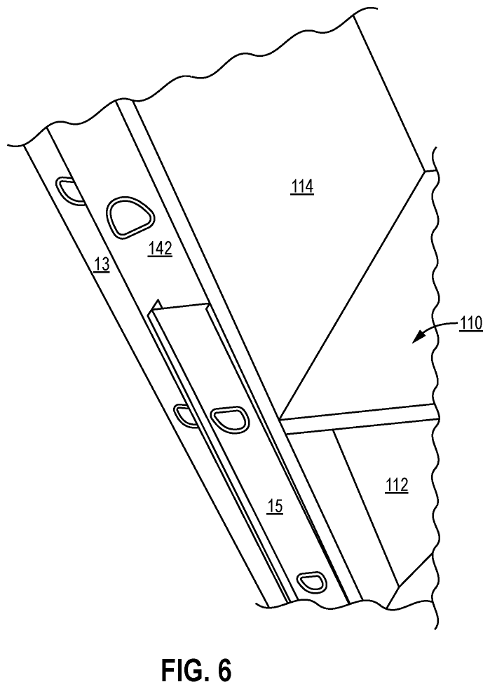

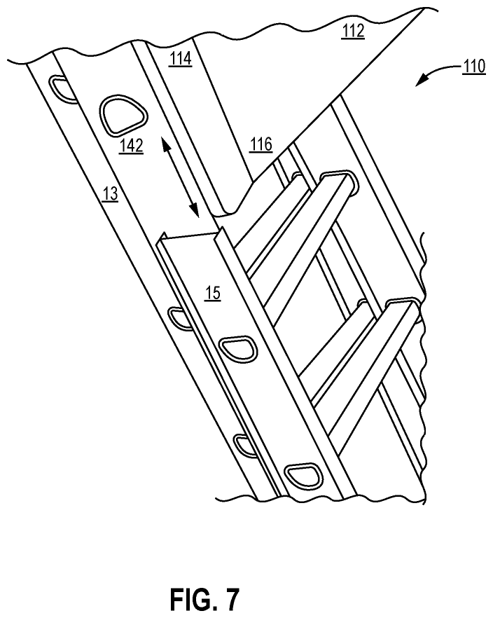

With reference to FIGS. 5-7, the shuttle 110 is shown movably connected to the extension ladder 11 as introduced in FIGS. 3 and 4. As shown particularly in FIG. 7, when the shuttle 110 reaches the trolley 142, both move upward together as the trolley 142 begins to carry the shuttle 110, which is indicated by a gap marked by the bold double-arrow between the ladder sections 13, 15.

By way of example and not of limitation, some embodiments of the present application could include the following, and combinations thereof, but are not limited to:

### Embodiment 1

Claim 1: A ladder lifting assembly, comprising:
a shuttle having a cradle configured for carrying a workpiece to an elevated position;
attachment means for movably connecting the shuttle to an extension ladder, the extension ladder being configured to extend to the elevated position;
a pulley assembly attached to the extension ladder, the pulley assembly including a cable attached to the shuttle; and
a hoist connected to the extension ladder, the cable connecting the hoist to the shuttle through the pulley assembly, wherein when the hoist is activated in a first state, the shuttle is raised in a direction of the elevated position, and wherein when the hoist is activated in a second state, the shuttle is lowered in a direction away from the elevated position.

### Embodiment 2

Claim 2: The ladder lifting assembly as in Claim 1, wherein the attachment means include a plurality of ladder blocks and a magnet pad.

### Embodiment 3

Claim 3: The ladder lifting assembly as in Claim 1 or 2, wherein the attachment means include a trolley.

### Embodiment 4

Claim 4: The ladder lifting assembly as in any of the preceding claims, wherein the hoist is a motorized winch disposed at an end of the extension ladder.

### Embodiment 5

Claim 5: The ladder lifting assembly as in any of the preceding claims, wherein the elevated position is a roof top.

### Embodiment 6

Claim 6: The ladder lifting assembly as in any of the preceding claims, further comprising a ground anchor assembly connected to the extension ladder, the ground anchor assembly including at least one anchor for anchoring the extension ladder to ground.

### Embodiment 7

Claim 7: A method of loading and elevating solar panels for installation, the method comprising:
providing a shuttle having a cradle to carry a solar panel;
providing an extension ladder;
extending the extension ladder to a desired elevation;
providing a motorized hoist;
attaching the hoist to the extension ladder;
movably attaching the shuttle to the extension ladder;
attaching a pulley system to the extension ladder;
connecting a cable to the shuttle and to the hoist, the cable extending through the pulley system;
loading the solar panel on the shuttle; and
activating the hoist and raising the solar panel on the shuttle along the extension ladder in a direction of the elevated position; and
unloading the solar panel from the shuttle.

### Embodiment 8

Claim 8: The method of loading and elevating solar panels for installation as in Claim 7, further comprising providing a ground anchor assembly connected to the extension ladder and anchoring the extension ladder to ground.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A ladder lifting assembly, comprising:
a shuttle having a cradle configured for carrying a workpiece to an elevated position;
attachment means for movably connecting the shuttle to an extension ladder, the extension ladder being configured to extend to the elevated position;
a pulley assembly attached to the extension ladder, the pulley assembly including a cable attached to the shuttle; and
a hoist connected to the extension ladder, the cable connecting the hoist to the shuttle through the pulley assembly, wherein when the hoist is activated in a first state, the shuttle is raised in a direction of the elevated position, and wherein when the hoist is activated in a second state, the shuttle is lowered in a direction away from the elevated position.

2. The ladder lifting assembly as in claim 1, wherein the attachment means is a plurality of ladder blocks and a magnet pad.

3. The ladder lifting assembly as in claim 1, wherein the attachment means is a trolley.

4. The ladder lifting assembly as in claim 1, wherein the hoist is a motorized winch disposed at an end of the extension ladder.

5. The ladder lifting assembly as in claim 1, wherein the elevated position is a roof top.

6. The ladder lifting assembly as in claim 1, further comprising a ground anchor assembly connected to the extension ladder, the ground anchor assembly including at least one anchor for anchoring the extension ladder to ground.

7. A method of loading and elevating solar panels for installation, the method comprising:
providing a shuttle having a cradle to carry a solar panel;
providing an extension ladder;
extending the extension ladder to a desired elevation;
providing a motorized hoist;
attaching the hoist to the extension ladder;
movably attaching the shuttle to the extension ladder;
attaching a pulley system to the extension ladder;
connecting a cable to the shuttle and to the hoist, the cable extending through the pulley system;
loading the solar panel on the shuttle; and
activating the hoist and raising the solar panel on the shuttle along the extension ladder in a direction of the elevated position; and
unloading the solar panel from the shuttle.

8. The method of loading and elevating solar panels for installation as in claim 7, further comprising providing a ground anchor assembly connected to the extension ladder and anchoring the extension ladder to ground.
